(19) United States
(12) Patent Application Publication
(10) Pub. No.: US 2013/0124478 A1
(43) Pub. Date: May 16, 2013

(54) DATA ANALYTICS REPORTING SYSTEM AND METHODS

(71) Applicant: SIMPLY MEASURED, INC., Seattle, WA (US)

(72) Inventors: Aviel P. GINZBURG, Seattle, WA (US); Damon P. CORTESI, Seattle, WA (US); J. Colin HENRY, Seattle, WA (US); Daniel E. WORTHINGTON, San Francisco, CA (US)

(73) Assignee: SIMPLY MEASURED, INC., Seattle, WA (US)

(21) Appl. No.: 13/655,324

(22) Filed: Oct. 18, 2012

Related U.S. Application Data
(60) Provisional application No. 61/558,681, filed on Nov. 11, 2011.

(51) Int. Cl. G06F 7/00; G06F 17/30

(52) U.S. Cl. 707/639; 707/E17.032

(57) ABSTRACT

A non-spreadsheet charting report showing dynamic data from a data feed may be designed by populating a spreadsheet template with a data snapshot of data currently collected to obtain a snapshot spreadsheet having rows and columns that map back to data fields of the data snapshot. A remote user can insert and/or modify one or more spreadsheet-chart elements to graphically depict aspects of the data snapshot. Report-presentation meta-data is then extracted from the modified spreadsheet, and a report-presentation template is generated for subsequent use. When a dynamic charting report is requested, updated data from the data feed is used to populate the report-presentation template.

### FIELD

The present disclosure relates to the field of data presentation, and more particularly, to generating data analytics reports based on real-time data.

### BACKGROUND

Data analytics reporting is concerned with analyzing raw data to extract useful information and presenting it in such a way so as to allow companies and organizations to make better business decisions. For example, customer relationship management (CRM) analytics reporting helps companies to perform profitability analysis, personalization, etc., based on data collected about their customers.

Real-time analytics reporting, based on real-time (i.e., live) data, provides up-to-date information that enables quicker and better business decisions. An example of real-time analytics reporting concerns with monitoring and analyzing social media contents, which include blogs, wikis, micro-blogs, social networking sites (e.g., Facebook, Google+, Twitter), media sharing websites (e.g., Youtube, Flickr), forums, message boards (e.g., Yelp, EHow), and any other user-generated content. Such reporting allows brands and marketers to determine, for example, the level of customer engagement and effectiveness of their marketing activities in real time.

One approach to generating data analytics reports involves the use of a traditional spreadsheet editor, such as Microsoft Excel. However, reports generated under this approach usually only reflect static data, not real-time data. Moreover, collaboration under this approach is difficult because it is difficult to keep track of individual changes made by different people.

Another approach is via web-based data analytics dashboard services (e.g., Google Analytics, Tableau). Some of these services may be coupled to data sources to produce real-time analytics reports. However, using these services usually requires a user to overcome a (often steep) learning curve. Moreover, these web-based services may limit user's ability to control how a report is generated because they provide only a limited set of features, compared to the relatively rich and powerful feature set offered by the traditional spreadsheet editors, such as Microsoft Excel.

### BRIEF DESCRIPTION OF THE DRAWINGS

FIG. 1 illustrates an exemplary data analytics reporting system, in accordance with one embodiment.

FIG. 2 illustrates several components of an exemplary reporting server, in accordance with one embodiment.

FIGS. 3a-c illustrate exemplary communications between reporting server, client device and data source, in accordance one embodiment.

FIG. 4 illustrates a reporting routine, in accordance with one embodiment.

FIG. 5 illustrates a subroutine for generating a snapshot spreadsheet, in accordance with one embodiment.

FIG. 6 illustrates a subroutine for generating a report-presentation template, in accordance with one embodiment.

FIG. 7 illustrates a subroutine for generating a non-spreadsheet charting report, in accordance with one embodiment.

FIG. 8 illustrates an exemplary snapshot spreadsheet, in accordance with one embodiment.

FIG. 9 illustrates an exemplary modified snapshot spreadsheet, in accordance with one embodiment.

FIG. 10 illustrates an exemplary non-spreadsheet charting report, in accordance with one embodiment.

FIGS. 11-15 illustrate various non-spreadsheet charting reports that may be designed and generated according to methods such as those described herein.

### DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

In various embodiments, a data analytics reporting server produces a snapshot spreadsheet based on data collected from a given data source. The generated snapshot spreadsheet contains mapping markups that provide the mapping between spreadsheet columns and data source fields. A user may modify the snapshot spreadsheet in a spreadsheet editor, for example, by adding spreadsheet-chart elements such as charts and diagrams. Marking markups are preserved by the spreadsheet editor. The modified snapshot spreadsheet is then processed to generate a report-presentation template having presentation-chart elements corresponding to the spreadsheet-chart elements that were added and/or modified by the user. The report-presentation template contains information (including mapping markups, formulas, and formatting information) necessary to render the presentation-chart elements, but it does not replicate all the data values in the modified snapshot spreadsheet. Finally, a non-spreadsheet charting report containing the presentation-chart element and based on current data is generated according to the report-presentation template. In particular, mapping markups are used to retrieve the current data used by the presentation-chart elements.

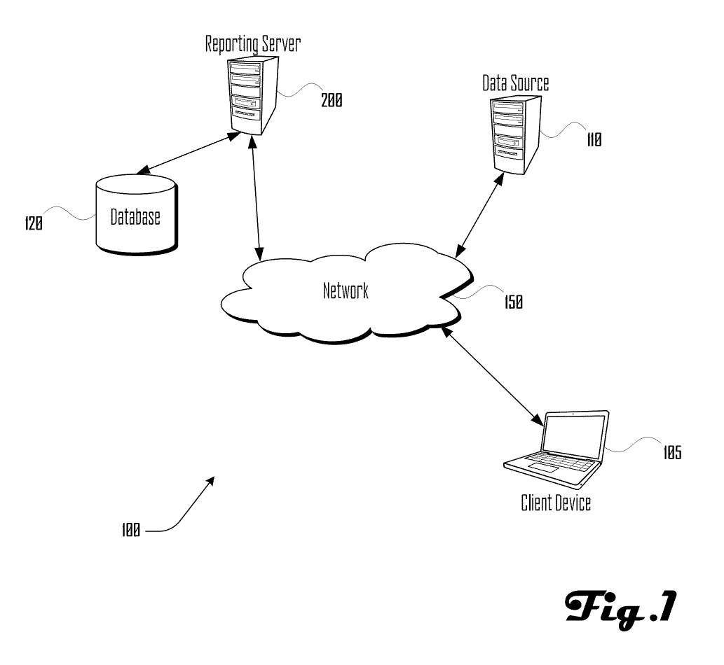

FIG. 1 illustrates an exemplary data analytics reporting system 100, in accordance with one embodiment, in which Reporting Server 200, Data Source 110, and Client Device 105 are connected to network 150. Reporting Server 200 is also in communication with database 120. In some embodiments, Reporting Server 200 may communicate with database 120 via network 150, a storage area network (“SAN”), a high-speed serial bus, and/or via other suitable communication.

In various embodiments, Reporting Server 200 may comprise one or more physical and/or logical devices that collectively provide the functionalities described herein. In some embodiments, Reporting Server 200 and/or database 120 may comprise one or more replicated and/or distributed physical or logical devices. In some embodiments, Reporting Server 200 and/or database 120 may comprise one or more computing resources provisioned from a “cloud computing” provider.

In various embodiments, network 150 may include the Internet, a local area network (“LAN”), a wide area network (“WAN”), a cellular data network, and/or other data network.

In various embodiments, Client Device 105 may include desktop PC, mobile phone, laptop, tablet, or other computing device that is capable of connecting to network 150.

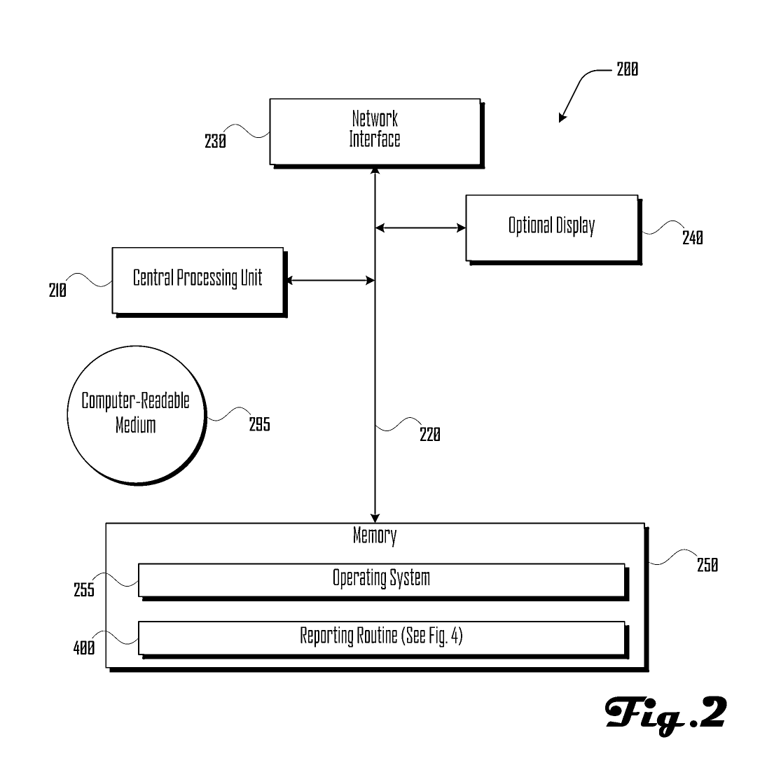

FIG. 2 illustrates several components of an exemplary Reporting Server 200 in accordance with one embodiment. In some embodiments, Reporting Server 200 may include more components than those shown in FIG. 2. However, it is not necessary that all of these generally conventional components be shown in order to disclose an illustrative embodiment. As shown in FIG. 2, Reporting Server 200 includes a network interface 230 for connecting to the network 150.

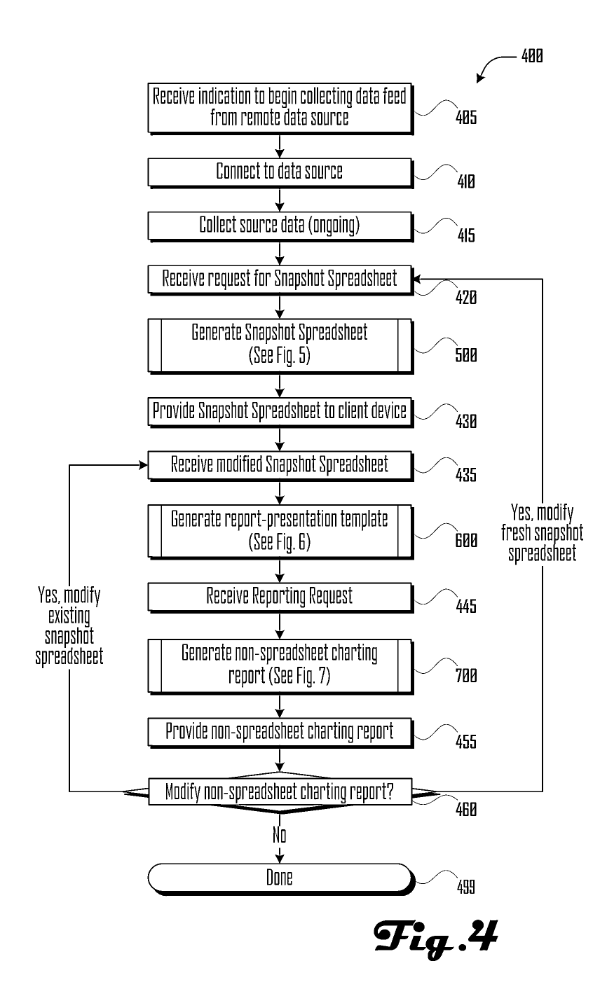

The Reporting Server 200 also includes a processing unit 210, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for a reporting routine 400 (see FIG. 4, discussed below). In addition, the memory 250 also stores an operating system 255. These software components may be loaded into memory 250 of the Reporting Server 200 using a drive mechanism (not shown) associated with a non-transient computer readable storage medium 295, such as a floppy disc, tape, DVD/CD-ROM drive, memory card, or the like. In some embodiments, software components may alternately be loaded via the network interface 230, rather than via a non-transient computer readable storage medium 295.

In some embodiments, a portion of the memory 250 may be used as a cache (not shown), which temporarily stores data so that future requests for the data can be served faster.

Reporting Server 200 also communicates via bus 220 with database 120 (see FIG. 1). In various embodiments, bus 220 may comprise a storage area network (“SAN”), a high-speed serial bus, and/or via other suitable communication technology. In some embodiments, Reporting Server 200 may communicate with database 120 via network interface 230.

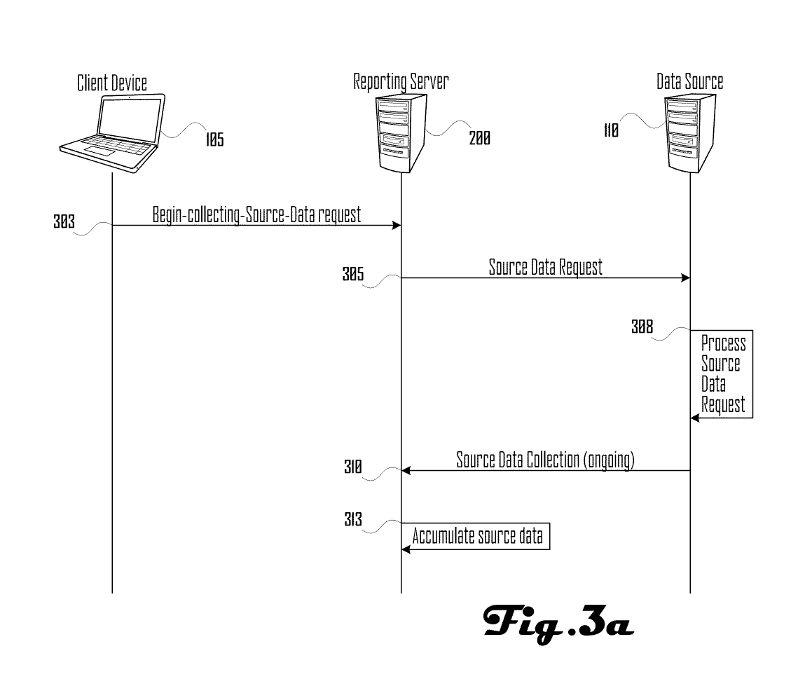

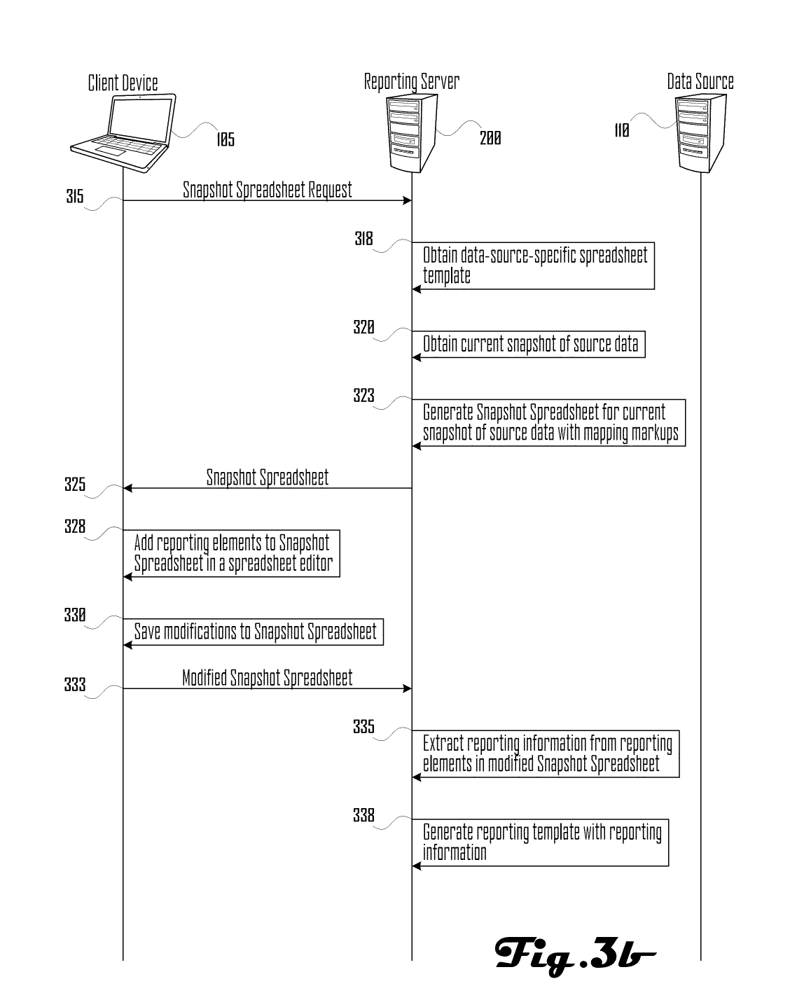

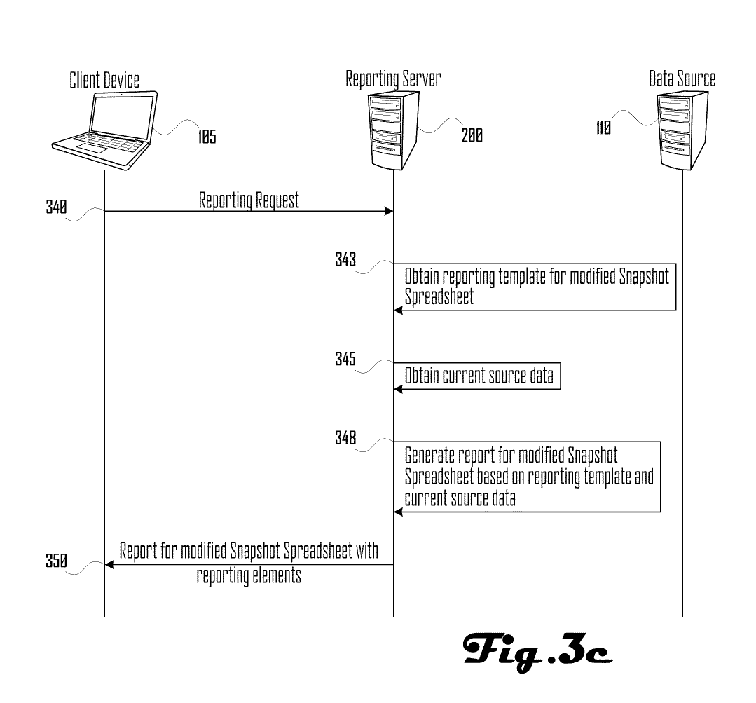

FIG. 3a-c illustrate an exemplary sequence of communications between Reporting Server 200, Client Device 105, and Data Source 110, in accordance with one embodiment. The illustrated series of communications shows an exemplary scenario in which the Reporting Server 200 generates a user-defined report for the Client Device 105 based on current data from Data Source 110.

Beginning the illustrated sequence of operations in FIG. 3a, Client Device 105 sends to Reporting Server a request 303 to begin collecting source data for subsequent reporting. In some embodiments, data collection request 303 may be sent in response to the user activating a control (e.g., a “Data Collection” button, link, or similar control) in a web browser on Client Device 105. In some embodiments, data collection indication 303 may include identifying information for Data Source 110 (e.g., connection information, network address, etc.) and queries to be performed.

In various embodiments, Data Source 110 enables Reporting Server 200 to access and collect various kinds of static or live data. For example, Data Source 110 may provide access to cloud-based data services, social media feeds (e.g., Twitter, provided by Twitter Inc. of San Francisco, Calif.; Facebook, provided by Facebook Inc. of Palo Alto, Calif.; Youtube, provided by Google Inc. of Mountain View, Calif.; and the like), financial market data feeds (e.g., from the New York Stock Exchange, NASDAQ Stock Market, and the like), and/or other like sources of dynamic data. In other embodiments, Data Source 110 may provide data including some or all of the following:
web analytics data;
email marketing data;
social advertising data;
search-engine optimization data;
search-engine marketing data;
paid media data;
customer relationship management data; and
marketing automation data.

In response to data-collection request 303, Reporting Server 200 sends to Data Source 110 a request 305 to access the source data identified by data-collection request 303. Data Source 110 processes 308 the source data request and returns the requested source data 310 to Reporting Server 200.

Reporting Server 200 stores 313 the source data thus received (e.g., in memory 250 or database 120). In the illustrated embodiment, once data collection is initiated, Reporting Server 200 requests, obtains, and accumulates source data in a continuous and/or periodic fashion. In some other embodiments, data collection is performed only upon requests from Client Device 105.

As shown in FIG. 3b, Client Device 105 sends to Reporting Server 200 a request 315 to provide a “Snapshot Spreadsheet” to Client Device 105. In some embodiments, a snapshot spreadsheet request 315 may be sent in response to the user activating a control (e.g., a “Download Spreadsheet” button, link, or similar control) in a web browser or other application on Client Device 105.

As used herein, the term “snapshot spreadsheet” refers to a user-editable document for designing and/or modifying at least one presentation-chart element related to a given data feed. Typically, a snapshot spreadsheet includes, among other things, a static copy (or “snapshot”) of a some or all of the data collected by Reporting Server 200 from a given data source (e.g., Data Source 110) as of a given point in time.

As used herein, the term “spreadsheet” refers to an editable document (or similar data structure) that includes one or more sets of tabular data (data that can be arranged in rows and columns of cells).

Cells are typically referred to by a combination of its column and row identifiers. A cell may contain “cell-data” values, which may include alphanumeric text or numeric values.

A cell may also contain formulas, which define how the content of a cell is calculated, for example, from constant values or from contents of other cells. Formulas are “non-cell-data” values.

Frequently, a spreadsheet also includes one or more spreadsheet-chart elements. As used herein, the term “spreadsheet-chart element” refers to a graphical representation that depicts a quantity and/or data relationship of the data. Frequently, spreadsheet-chart elements are used to highlight certain aspects of the data, including trends, exceptions, and the like.

In various embodiments, spreadsheet-chart elements may include charts, diagrams, pictures, and the like. For example, a bar chart may show the engagement level of fans for a Facebook Page over time, a pie chart may show the demographics of the followers subscribed to a Twitter account, and so on. Note that as used herein, “spreadsheet-chart elements” do not include tabular data displays that merely display cell values in rows and columns, such as are commonly used when editing cell values in a spreadsheet editor.

In some embodiments, a spreadsheet is a document that conforms to the ECMA-376 Standard (http://www.ecma-international.org/publications/standards/Ecma-376.htm). The ECMA-376 Standard specifies a family of XML schemas, collectively called Open XML (OpenXML), which defines the vocabularies for, among other things, spreadsheet documents.

In some other embodiments, a spreadsheet may be a document that conforms to other standards such as Open Document Format (ODF, http://www.oasis-open.org/committees/tc_home.php?wg_abbrev=office).

In various embodiments, a snapshot spreadsheet also contains mapping markups that provide mappings between one or more spreadsheet columns and one or more data source fields. In some embodiments, mapping markups are not visible to the users of the spreadsheets in a spreadsheet editor. In various embodiments, data source fields may include columns, fields and attributes.

In some embodiment, mapping markups may include <spreadsheet column, data source field> pairs for each row of the snapshot spreadsheet data. In other embodiments, mapping markups may also include queries, data source connection information, and the like.

Current spreadsheet specifications may not explicitly support such mapping between spreadsheet columns and data source fields. Therefore, in some embodiments, mapping markups may be implemented via an external metadata file that is not provided to the remote user. In other embodiments, mapping markups may be implemented with custom extensions to the spreadsheet specifications. For example, in one exemplary embodiment, mapping markups may be implemented by storing mapping information in extension lists preceded by the <ext> tag under the ECMA-376 Standard.

In other embodiments, mapping markups may be implemented via a naming convention for user-editable metadata, such as named ranges. For example, the ECMA-376 Standard allows for arbitrary ranges of cells to be given names, such that the range may be accessed by name, rather than by its row and column designations. In one embodiment, such a named-range facility may be used to facilitate mapping spreadsheet columns and/or rows to an underlying data source. For example, Table 1 shows a simplified set of range names that may be used to map various columns of a given snapshot spreadsheet to various fields of data that may be collected from a data feed from a micro-blogging service.

TABLE 1
Exemplary named range mappings

| Spreadsheet Row/Column Identifier | Range name |
|---|---|
| Sheet1!$B:$B | tweet.DATE |
| Sheet1!$A:$A | tweet.AUTHOR |
| Sheet1!$C:$C | tweet.MESSAGE |

Referring again to FIG. 3b, in response to snapshot spreadsheet request 315, Reporting Server 200 obtains 318 a spreadsheet template that is specific to the Data Source 110. For example, a spreadsheet template associated with a micro-blogging data feed may include named ranges such as those shown above in Table 1. Reporting Server 200 also obtains 320 a current snapshot of source data collected from Data Source 110.

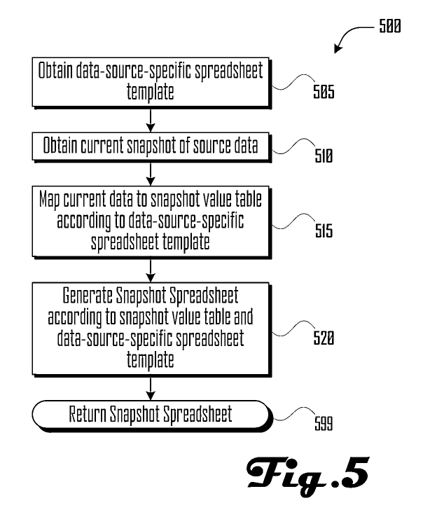

Using the data-source-specific spreadsheet template, Reporting Server 200 generates 323 a snapshot spreadsheet populated with the current snapshot of source data and mapping various spreadsheet rows and columns back to appropriate data fields of data collected from Data Source 110. More details on the generation of the snapshot spreadsheet are provided in the discussion of FIG. 5.

Upon receiving the snapshot spreadsheet 325 from Reporting Server 200, Client Device 105 allows a user to access and modify 328 the snapshot spreadsheet using a spreadsheet editor of his/her choice.

As used herein, the term “spreadsheet editor” refers to a computer application that allows a user to view, edit, and save to a spreadsheet. In various embodiments, a spreadsheet editor may be a stand-alone spreadsheet editor or an online spreadsheet editor. A stand-alone spreadsheet editor runs on the Client Device 105. Examples of a stand-alone spreadsheet editor include Microsoft Excel (provided by Microsoft Corporation of Redmond, Wash.), Apple Numbers (provided by Apple Inc. of Cupertino, Calif.), OpenOffice.org Calc (provided by Oracle Corporation of Redwood City, Calif. in association with the Open Source community), and IBM Lotus 1-2-3 (provided by International Business Machines Corporation of Armonk, N.Y.). An online spreadsheet editor is a third-party, web-based or cloud-based application. Examples of an online spreadsheet editor include Google Docs (provided by Google Inc. of Mountain View, Calif.), Office Web Apps (provided by Microsoft Corporation) and Zoho Office Suite (provided by Zoho Corporation of Pleasanton, Calif.).

A user's modifications to the snapshot spreadsheet may include adding, changing or removing cell-data values, and non-cell-data values, such as formulas, and spreadsheet-chart elements. For example, a user may define a formula to sum the cell-data values of a set of cells, add a bar chart showing engagement level of fans for a Facebook Page over time, or the like.

When the user finishes modifying snapshot spreadsheet, he or she may save 330 the modifications to the snapshot spreadsheet. In general, a spreadsheet editor should preserve (e.g., not change or remove) any standards-compliant mapping markups contained in a snapshot spreadsheet when it is opened, edited, and/or saved in the spreadsheet editor. For example, Microsoft Excel, which supports the ECMA-376 Standard, preserves any ECMA-376-compliant custom markups stored under the <ext> tag.

After saving the modifications to the snapshot spreadsheet, the user may upload the modified snapshot spreadsheet 333 to Reporting Server 200. In some embodiments, a modified snapshot spreadsheet may be uploaded in response to the user activating a control (e.g., a “Upload” button, link, or similar control) in a web browser or other application on Client Device 105.

Upon receiving the modified snapshot spreadsheet, the Reporting Server 200 extracts 335 report-presentation meta-data from the modified snapshot spreadsheet (e.g., spreadsheet-chart elements, mapping markups, formulas) and generates 338 a report-presentation template containing the extracted report-presentation meta-data. More details on the generation of report-presentation templates are provided in the discussion of FIG. 6.

As used herein, the term “report-presentation meta-data” refers to the information extracted from the modified snapshot spreadsheet that is required to render a non-spreadsheet “charting report”.

As used herein, the term “charting report” refers to a presentation of data analytics that includes the spreadsheet-chart elements derived from a user-modified snapshot spreadsheet. For example, a report may include a bar chart showing engagement level of fans for a Facebook Page over time, a pie chart showing the demographics of the people subscribed to a Twitter account, or the like.

In some embodiments, a non-spreadsheet charting report may be implemented as a document or a collection of documents, e.g., in HTML, XML or JSON format, that is suitable to be rendered in a web browser. In some embodiments, a non-spreadsheet charting report may include a Microsoft PowerPoint presentation. In some other embodiments, a non-spreadsheet charting report may include a PDF file.

In various embodiments, report-presentation meta-data specifies how spreadsheet-chart elements are to be presented. For example, report-presentation meta-data for a chart may include its position coordinates relative to the drawing frame, the type of chart (e.g., bar chart, pie chart, etc.), the colors and styles of the chart, etc. As another example, report-presentation meta-data for a diagram may include references to the set of data contained in the diagram and layout information.

In various embodiments, report-presentation meta-data includes mapping markups, formulas and other non-cell-data values of the modified snapshot spreadsheet. However, in various embodiments, report-presentation meta-data excludes some or all of the cell-data values of the modified snapshot spreadsheet.

As used herein, the term “report-presentation template” refers to a data structure that stores report-presentation meta-data of the modified snapshot spreadsheet, such that reports can be subsequently generated and populated with subsequently collected data from Data Source 110.

Referring now to FIG. 3c, Client Device 105 sends to Reporting Server 200 a request 340 to generate a non-spreadsheet charting report. In some embodiments, reporting request 340 is sent in response to the user activating a control (e.g., a “Generate Report” button, link, or similar control) in a web browser or other application on Client Device 105. In some other embodiments, Client Device 105 automatically sends a reporting request 340 to Reporting Server 200, for example, after the user uploads a modified snapshot spreadsheet to Reporting Server 200.

Upon receiving the reporting request 340, Reporting Server 200 obtains 343 the report-presentation template previously derived from the modified snapshot spreadsheet. Next, Reporting Server 200 obtains 345 the currently-collected source data. (As described earlier, in the illustrated embodiment, Reporting Server 200 performs data collection on an ongoing basis.)

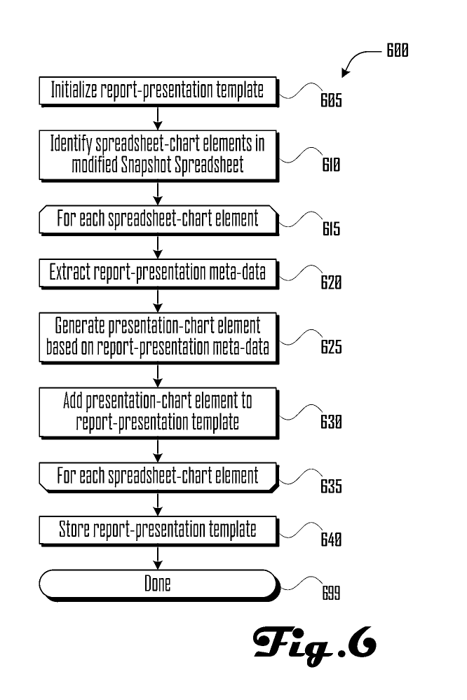

Reporting Server 200 generates 348 a non-spreadsheet charting report that includes spreadsheet-chart elements of the modified snapshot spreadsheet based on the report-presentation template, but using currently-collected source data. Finally, Reporting Server 200 sends the generated non-spreadsheet charting report 350 to Client Device 105. More details on the generation of non-spreadsheet charting reports are provided in the discussion of FIG. 7.

FIG. 4 illustrates a reporting routine 400, such as may be performed by Reporting Server 200 in accordance with one embodiment. In block 405, routine 400 receives an indication (e.g., from Client Device 105) to begin collecting a source data feed from a given data source (e.g., Data Source 110). For example, in one embodiment, routine 400 may receive an indication to begin collecting certain specified tweets, status updates, or other items posted to a specified service such as Twitter (provided by Twitter Inc. of San Francisco, Calif.), Facebook (provided by Facebook, Inc. of Palo Alto, Calif.), or other social networking, blogging, and/or microblogging service. Other embodiments may access and collect other kinds of data from other accessible data sources.

In various embodiments, the indication may specify that routine 400 should collect items meeting one or more specified criteria, such as items that are posted by, that mention, or that are otherwise associated with an identified person, user, company, product, or other entity.

In block 410, routine 400 connects to the indicated data source, and in block 415, routine 400 begins to collect and store the indicated data feed (e.g., in memory 250, database 120, or the like). As described earlier, in some embodiments, Reporting Server 200 performs data collection on an ongoing basis. In various embodiments, the data feed comprises a stream of records, each record having several data fields (e.g., date, ID, author, and the like).

In block 420, routine 400 receives a request (e.g., from Client Device 105) to provide a user-editable document for designing and/or modifying at least one presentation-chart element related to the given data feed.

In block 500 (see FIG. 5, discussed below), routine 400 generates a snapshot spreadsheet populated with records and fields from a snapshot of the currently collected source data. As described above, in various embodiments, the generated snapshot spreadsheet also includes mapping markups specifying the mappings between spreadsheet columns and data source fields.

In block 430, routine 400 provides the generated snapshot spreadsheet to the requestor (e.g., an operator of Client Device 105) for modification in a spreadsheet editor of the requestor's choice, including inserting and/or modifying at least one spreadsheet-chart element to graphically depict a quantity and/or data relationship of the first data snapshot.

In block 435, routine 400 receives a user-modified snapshot spreadsheet. In various embodiments, a user may have added, changed, and/or removed cell-data values, formulas, and/or spreadsheet-chart elements in a spreadsheet editor. As described earlier, the spreadsheet editor generally preserves the mapping markups included in the snapshot spreadsheet.

In block 600 (see FIG. 6, discussed below), routine 400 generates a report-presentation template based on the modified snapshot spreadsheet received in block 435. As described earlier, the report-presentation template includes report-presentation meta-data extracted from the modified snapshot spreadsheet, but excludes some or all of the cell-data values from the modified snapshot spreadsheet.

In block 445, routine 400 receives a request (e.g., from Client Device 105) to generate a non-spreadsheet charting report reporting currently-collected data according to the report-presentation template.

In block 700 (see FIG. 7, discussed below), routine 400 generates a non-spreadsheet charting report with the currently-collected source data based on the report-presentation template generated in block 600 from the modified snapshot spreadsheet received in block 435.

In decision block 460, routine 400 determines whether the requestor wishes to further modify the non-spreadsheet charting report. If not, then routine 400 ends in block 499. Otherwise, if the requestor wishes to further modify the non-spreadsheet charting report, then routine 400 may loop back to either block 420 or block 435, depending on the requestor's indication.

In some embodiments, the requestor may indicate that he or she wants to further modify the existing snapshot spreadsheet. In that case, routine 400 loops back to block 435. In other embodiments, the requestor may indicate that he or she wants to modify a fresh snapshot spreadsheet with currently collected source data. In that case, routine 400 loops back to block 420. Routine 400 ends in block 499.

FIG. 5 illustrates a subroutine 500 for generating a snapshot spreadsheet, in accordance with one embodiment. In block 505, subroutine 500 obtains a spreadsheet template specific to a given data source. In various embodiments, the data-source-specific spreadsheet template includes mappings between spreadsheet columns and data source fields.

Data collected from a given data source typically has a particular structure. For example, data items collected from a microblogging or blogging service data source may be structured in various “fields” as indicated in Table 2.

TABLE 2
Exemplary data-feed records

| Item ID | Author | Date | Message |
|---|---|---|---|
| 1234 | simplymeasured | Nov. 1, | Hey Seattle: we're co-hosting |
| | | 2011 | the SEA Twitter Dev Teatime |
| 1235 | simplymeasured | Oct. 28, | A new *free* Facebook Insights |
| | | 2011 | report that makes you look |
| | | | like a data rockstar. |

In one embodiment, a spreadsheet template specific to that data source might indicate that column “A” of the spreadsheet template maps to the “Author” field of data items collected from the data source; that column “B” of the spreadsheet template maps to the “Date” field of data items collected from the data source; and that column “C” of the spreadsheet template maps to the “Message” field of data items collected from the data source. Cf Table 1: Exemplary named range mappings, above.

In some embodiments, the data-source-specific spreadsheet template may be implemented by lists, arrays, tables, or other data structures. In some other embodiments, the data-source-specific spreadsheet template may be implemented by a human- and/or machine-readable data file, such as a YAML or XML file. For example, in one exemplary embodiment, the data-source-specific spreadsheet template is implemented by an ECMA-376-compliant spreadsheet, which includes mapping markups in the customized extension columns denoted by the <ext> tags, or that includes mapping markups embedded in names of named ranges of cells.

In some embodiments, data-source-specific spreadsheet templates may be stored in a storage device (e.g., memory 250 or database 120) that is connected to the Reporting Server locally or remotely. In some embodiments, they may be stored by a cloud-based storage service provider. In some embodiments, data-source-specific spreadsheet templates may be stored at the same location. In some other embodiments, they may be stored at different locations.

In some embodiments, data-source-specific spreadsheet templates may be provided by the user. In some other embodiments, they may be generated by the system.

Still referring to FIG. 5, in block 510, subroutine 500 obtains a snapshot of some or all source data (e.g., from memory 250 or database 120) that has been collected from the given data source. For example, in one embodiment, subroutine 500 obtains currently-collected data such as that shown in Table 2, above.

In block 515, subroutine 500 maps the current snapshot of source data to a snapshot value table according to the data-source-specific spreadsheet template. In various embodiments, snapshot value table is a data structure that holds the current snapshot data according to the mapping between spreadsheet columns and data source fields specified by the data-source-specific spreadsheet template. For example, data from Table 2, above, might be mapped to a three-column, two-row snapshot value table as shown in Table 3

TABLE 3

| | A | B | C |
|---|---|---|---|
| 1 | simplymeasured | Nov. 1, 2011 | Hey Seattle: we're co-hosting |
| | | | the SEA Twitter Dev Teatime |
| 2 | simplymeasured | Oct. 28, 2011 | A new *free* Facebook |
| | | | Insights report that makes you |
| | | | look like a data rockstar. |

In block 520, subroutine 500 generates a snapshot spreadsheet according to the snapshot value table and data-source-specific spreadsheet template. In particular, the generated snapshot spreadsheet contains mapping markups in accordance with the data-source-specific template. For example, in one exemplary embodiment, the generated snapshot spreadsheet conforms to the ECMA-376 Standard and includes mapping markups stored in the customized extension columns denoted by the <ext> tags and/or in names of one or more named ranges.

For example, a snapshot spreadsheet generated from Table 3 may include mapping markups mapping columns A, B, and C to the “Author”, “Time”, and “Message” fields (respectively). Additionally rows 1 and 2 may be explicitly or implicitly mapped to data records having “Item ID” values of 1234 and 1235 (respectively), as collected from the data source.

Thus, the generated snapshot spreadsheet contains cell-data values that correspond to the values in the snapshot value table.

In some embodiments, the generated snapshot spreadsheet may be stored in a local or remote storage device (e.g., memory 250 or database 120). In some embodiments, the generated snapshot spreadsheet may be stored by a cloud-based storage service provider.

Finally, in block 599, subroutine 500 returns the generated snapshot spreadsheet to the caller.

FIG. 6 illustrates a subroutine for generating a report-presentation template based on a user-modified snapshot spreadsheet, in accordance with one embodiment.

In block 605, subroutine 600 initializes a report-presentation template. As described above, a report-presentation template refers to a data structure that stores report-presentation meta-data (e.g., reporting elements, mapping markups, formulas) of the modified snapshot spreadsheet. Moreover, a report-presentation template excludes some or all of the cell-data values in the modified snapshot spreadsheet.

In some embodiments, a report-presentation template may be implemented by a data file (e.g., an ECMA-376-compliant spreadsheet). In some other embodiments, a report-presentation template may be implemented by data structures such as lists, arrays, tables, and the like. In yet some other embodiments, a report-presentation template may be implemented by objects with data fields and methods. In such embodiments, a report-presentation template is initialized by creating the appropriate data structure and/or objects.

In some embodiments, a report-presentation template may be initialized based on a set of parameters, such as the data source for the report, the size of the snapshot spreadsheet, and the like.

In some embodiments, initialization of the report-presentation template includes extracting report-presentation meta-data (e.g., mapping markups, formulas, reporting elements, and the like) from a user-modified snapshot spreadsheet. In blocks 610-635, subroutine 600 iterates through all the spreadsheet-chart elements included in the modified snapshot spreadsheet, extracts report-presentation meta-data from each of the spreadsheet-chart elements, and stores that information in the report-presentation template.

In block 610, subroutine 600 identifies one or more spreadsheet-chart elements in the modified snapshot spreadsheet. In an exemplary embodiment, identifying spreadsheet-chart elements may involve parsing the snapshot spreadsheet to seek identifiers (e.g., <chart> tag in XML) preceding spreadsheet-chart elements.

Beginning in opening loop block 615, subroutine 600 processes each spreadsheet-chart element in turn. In block 620, subroutine 600 extracts report-presentation meta-data from the reporting element. As discussed above, report-presentation meta-data associated with a spreadsheet-chart element dictates how the spreadsheet-chart element is to be presented. For example, report-presentation meta-data for a chart may include its position coordinates relative to the drawing frame, the type of chart (e.g., bar chart, pie chart, etc.), the colors and styles of the chart, etc. As another example, report-presentation meta-data for a diagram may include reference to the set of data contained in the diagram and layout information.

In block 625, subroutine 600 generates a presentation-chart element that encapsulates the report-presentation meta-data for the current spreadsheet-chart element. In some embodiments, a presentation-chart element may be a data structure with data fields and/or methods. In some other embodiments, a presentation-chart element may be a data file (e.g., an XML file).

In block 630, the presentation-chart element for the current spreadsheet-chart element is added to or otherwise associated with the report-presentation template. In closing loop block 635, subroutine 600 iterates back to opening loop block 615 to process the next reporting spreadsheet-chart element, if any. Once all spreadsheet-chart elements have been processed, subroutine 600 proceeds to block 640.

In block 640, subroutine 600 stores the report-presentation template. In some embodiments, report-presentation template may be stored in a data compression and archive format (e.g., as a ZIP file). In some other embodiments, report-presentation template may be stored in an uncompressed format.

In various embodiments, report-presentation templates and/or presentation-chart elements may be stored in a local or remote storage device (e.g., memory 250 or database 120). In some embodiments, they may be stored by a cloud-based storage service provider. In some embodiments, report-presentation templates and/or presentation-chart elements may be stored at the same location. In some other embodiments, they may be stored at different locations.

Subroutine 600 ends in block 699.

FIG. 7 illustrates a subroutine for generating a non-spreadsheet charting report, in accordance with one embodiment. In block 705, subroutine 700 obtains the report-presentation template associated with a given data source and a given modified snapshot spreadsheet. In some embodiments, each modified snapshot spreadsheet is identifiable by a unique identifier and the Reporting Server 200 maintains a data structure (e.g., list, array, table, or the like) that keeps track of the mapping between the unique identifier of a modified snapshot spreadsheet to its corresponding report-presentation template.

In block 710, a non-spreadsheet charting report is initialized. As described above, a non-spreadsheet charting report is a presentation of data analytics that includes presentation-chart elements derived from spreadsheet-chart elements of a user-modified snapshot spreadsheet. In some embodiments, a non-spreadsheet charting report may be implemented as a document or a collection of documents, e.g., in HTML, XML or JSON format, that is suitable to be rendered in a web browser or other graphical-report rendering environment. For example, in one embodiment, a report may be generated for interactive rendering within a web browser using a charting library or plug-in such as the Highcharts JS library (provided by Highsoft Solutions AS of Viki i Sogn, Norway). In some embodiments, a report may generated for rendering in presentation software such as PowerPoint (provided by Microsoft Corporation of Redmond, Wash.). In some other embodiments, a report may generated for static rendering, such as in a Portable Document Format (“PDF”) reader.

In some embodiments, the non-spreadsheet charting report is initialized based on the report-presentation template. For example, the non-spreadsheet charting report may be initialized to use some report-presentation meta-data (e.g., fonts, colors) contained in the report-presentation template. In some other embodiments, the non-spreadsheet charting report may be initialized based on user-inputs. For example, the non-spreadsheet charting report may be initialized based on a user-provided Microsoft PowerPoint document with the desired formatting information (e.g., background, fonts, etc.). In yet some other embodiments, the non-spreadsheet charting report may be initialized according to a set of parameters, such as the type of report, the data source for the report, the type of the target audience for the report, etc.

In block 715, subroutine 700 obtains currently collected source data corresponding to the given data source (which may have been updated since the last time the report-presentation template was modified or generated).

Beginning in opening loop block 720, subroutine 700 processes each presentation-chart element in the report-presentation template in turn. As discussed above, a presentation-chart element of the report-presentation template corresponds to a chart, graph, or other spreadsheet-chart element from a snapshot spreadsheet that was modified by a user.

In block 725, subroutine 700 obtains, from the report-presentation template, report-presentation meta-data associated with the current presentation-chart element. As described earlier, report-presentation meta-data may include formulas, mapping markups, formatting information, and the like. In some embodiments, report-presentation meta-data is obtained by accessing one or more data fields in the reporting object. In some other embodiments, report-presentation meta-data is obtained by invoking a method or methods on the report-presentation template.

In block 730, subroutine 700 adds the presentation-chart element to the non-spreadsheet charting report based on the report-presentation meta-data obtained in block 725 and the currently-collected source data. For example, in one exemplary embodiment, subroutine 700 may determine the set of cell-data values required for rendering the reporting element. Subroutine 700 may then obtain the currently-collected source data that corresponds to the above-mentioned set of cell-data values. Moreover, if any of the cell references contain formulas (part of the report-presentation meta-data), those formulas may be calculated based on the currently-collected source data as well.

Once the current data for the presentation-chart element is obtained, the presentation-chart element is translated into a set of instructions and/or data (e.g., in HTML, XML or JSON) to instruct the report's rendering environment to render a data-analytic display or chart according to the report-presentation meta-data (e.g., formatting information).

In closing loop block 735, subroutine 700 iterates back to opening loop block 720 to process the next presentation-chart element in the report-presentation template, if any. Once all presentation-chart elements have been processed, subroutine 700 proceeds to block 799.

In block 799, subroutine 700 returns the generated non-spreadsheet charting report to the caller to be provided to and rendered on the requesting device. In some embodiments, the report is stored and a Uniform Resource Identifier (URI) or other identifier that identifies the location of the generated report is returned.

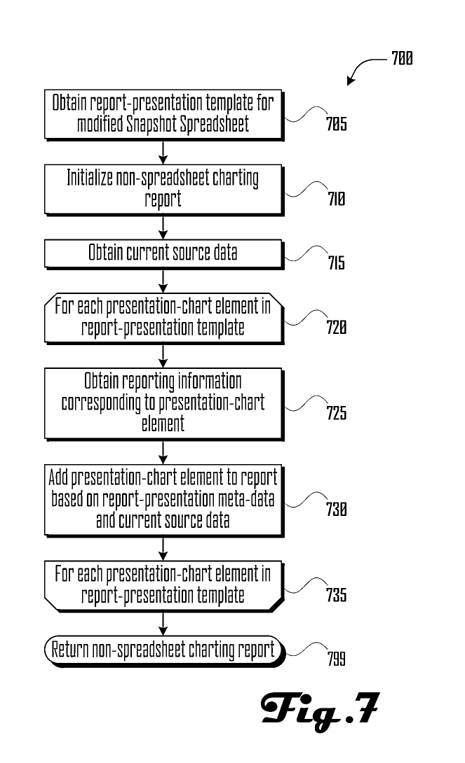

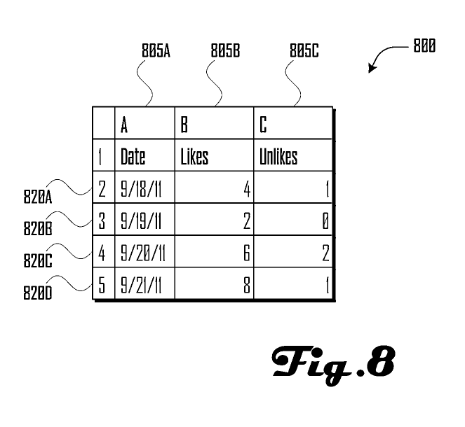

FIGS. 8-10 illustrate an example in which Reporting Server 200 generates a report of the number of net daily likes for a Facebook Page over a period of time. To start with, Client Device 105 sends a source data collection initiation request to Reporting Server 200 to collect data from Data Source 200. The Data Source 110 may support Graph API (provided by Facebook, Inc.), which allows a user to query data about a particular Facebook object (such as a Page) using its unique ID or username. For example, Reporting Server 200 may send one of the following request to Data Source 110 to fetch all public information associated with the Coca-Cola Facebook Page through Graph API:

https://graph.facebook.com/40796308305
https://graph.facebook.com/cocacola

The response from Data Source 110 may include the following data in an JSON: object:

```
{
  “id”: “40796308305”,
  “name”: “Coca-Cola”,
  “picture”: “http://profile.ak.fbcdn.net/hprofile-ak-
snc4/276879_40796308305_1578420141_s.jpg”,
  “link”: “http://www.facebook.com/coca-cola”,
  “likes”: 35721418,
  “category”: “Food/beverages”,
  “website”: “http://www.coca-cola.com”,
  “username”: “coca-cola”,
  “founded”: “1886”,
  “products”: “Coca-Cola is the most popular and biggest-selling
  soft drink in history....”,
  “location”: {
    “latitude”: 42.00736,
    “longitude”: −72.521224
  },
  “can_post”: true,
  “checkins”: 74
}
```

Reporting Server 200 may also query Data Source 200 for additional information after obtaining access token from a Facebook user. An access token authorizes requests on behalf of that user. For example, the following request obtains the field “likes” associated with the Coca-Cola Facebook Page using an access token:

https://graph.facebook.com/cocacola/likes?access_token= . . .

In this example, to query the daily likes added and likes removed for a given Facebook Page with object id 12345, Reporting Server 200 may issue the following HTTP GET request to the query the “page_like_adds” and “page_like_removes” fields of the insight table (which provides daily-aggregated metrics about a page).

GET
/fql?q=SELECT+date+likes+unlikes+FROM+insights+WHERE+
object_id=12345+AND+likes=page_like_adds+
AND+unlikes=page_like_removes+AND+date=’2011-9-18’

The data collected in response may include the following:

```
{
  “date”: “2011-9-18”,
  “likes”: “4”,
  “unlikes”: “1”
}
```

FIG. 8 illustrates an exemplary snapshot spreadsheet generated by the Reporting Server 200, in accordance with one embodiment. Each row of data 820-835 represents a record in the insight table described above. Each column of the snapshot spreadsheet 805-815 represents the data source fields that the user wants to analyze. Note that the snapshot spreadsheet also contains mapping markups, not visible in FIG. 8, that maps the data source fields to the spreadsheet columns. In this case, for example, mapping markups would include a mapping between spreadsheet column A 805A and source data field “date”, between spreadsheet column 805B and source data field “page_like_adds”, and between spreadsheet column C 805C and source data field “page_like_removes”.

The generated snapshot spreadsheet includes a current snapshot of source data that has been collected by the Reporting Server 200. In this case, assuming Reporting Server 200 started collecting data on Sep. 18, 2011 and the snapshot spreadsheet is generated on Sep. 21, 2011, the snapshot spreadsheet contains all the data collected between these dates. As described above, Reporting Server 200 may collect data on an ongoing basis. Since the insight table contains daily aggregated metrics, Reporting Server 200 may collect data from the insight table on a daily basis.

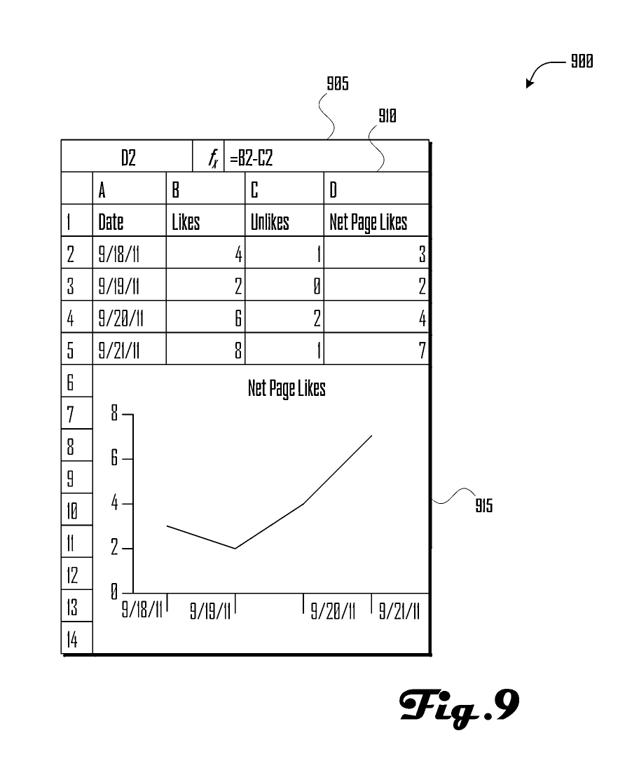

After the user receives the generated snapshot spreadsheet, she or he may modify the snapshot spreadsheet to add additional calculations and spreadsheet-chart elements. FIG. 9 illustrates an exemplary modified snapshot spreadsheet, in accordance with one embodiment. Here, the user added a calculated column D 910, which represents the net page-likes for a page. To that end, the user defines the content of column D 910 as the number of likes (column B) minus the number of unlikes (column C). For example, the user may define a formula 905 to calculate the value of cell D2 as “B2−C2”.

Moreover, the user may add spreadsheet-chart elements to the snapshot spreadsheet. In this example, the user added a line chart 915 where the x-axis represents the date (column A) and the y-axis represents the calculated net page-likes (column D 910).

After the modifying the snapshot spreadsheet 900, the user may upload it to the Reporting Server 200, which generates a report-presentation template that encapsulates the report-presentation meta-data for the modified snapshot spreadsheet. In this case, the report-presentation meta-data may include, e.g., the formula 905 for the added column D 910, the chart 915 and the mapping markups, not shown.

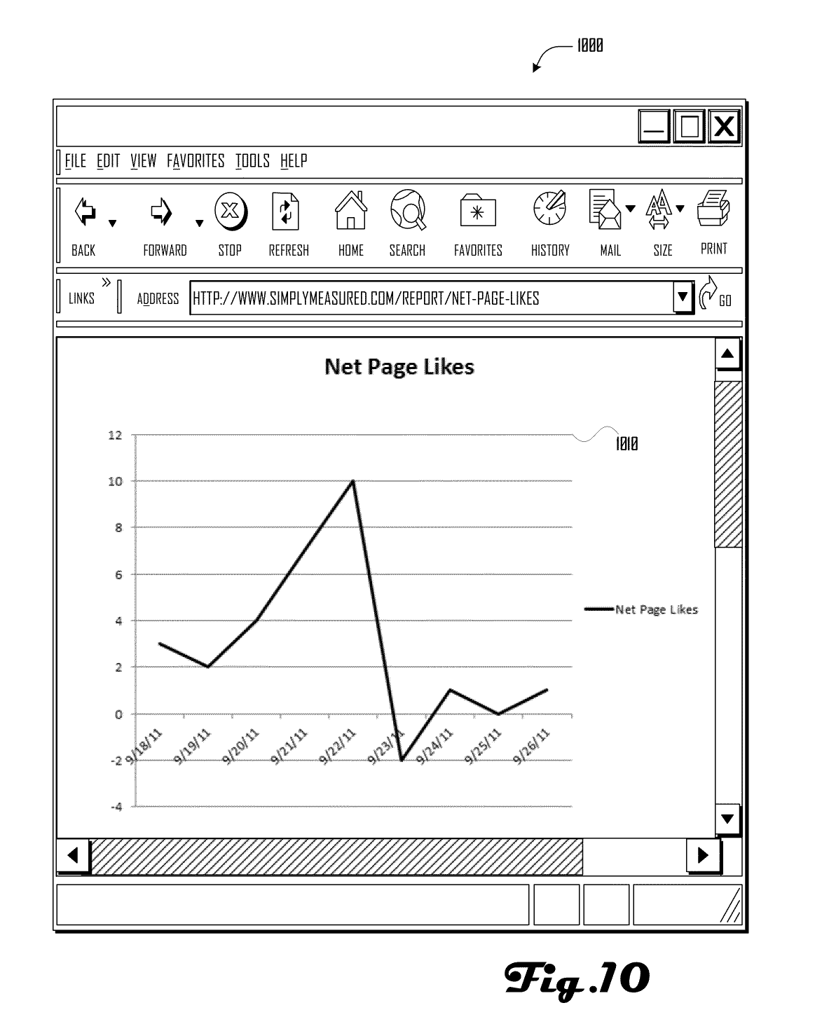

FIG. 10 illustrates an exemplary non-spreadsheet charting report, in accordance with one embodiment.

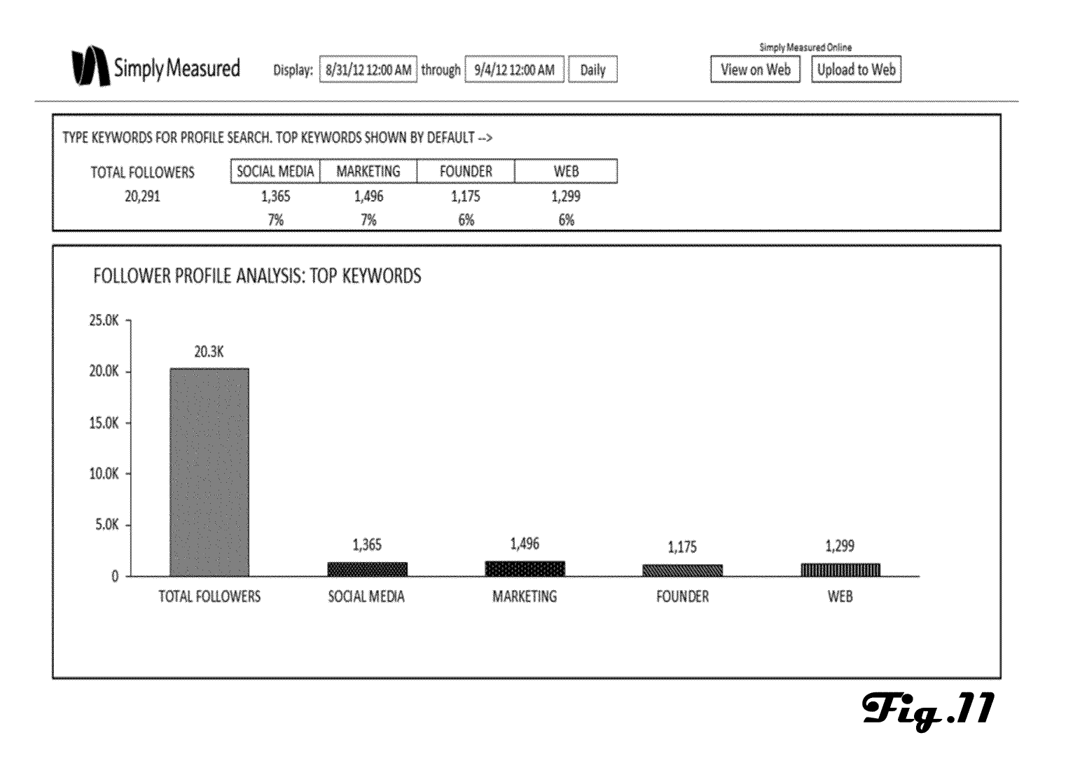

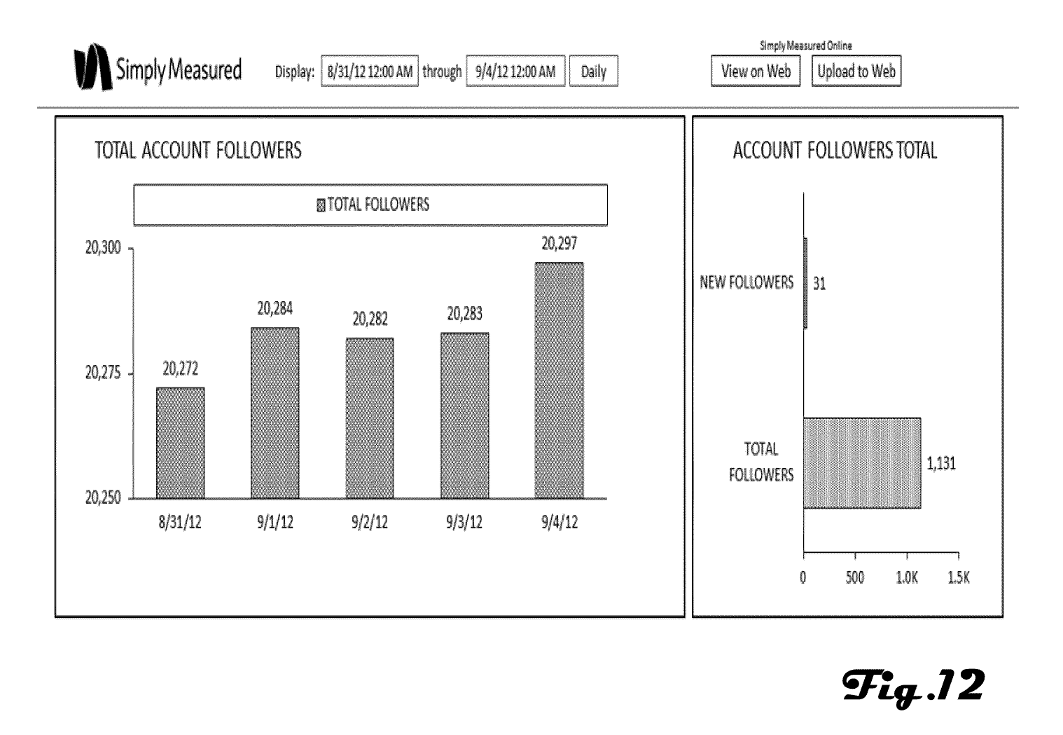

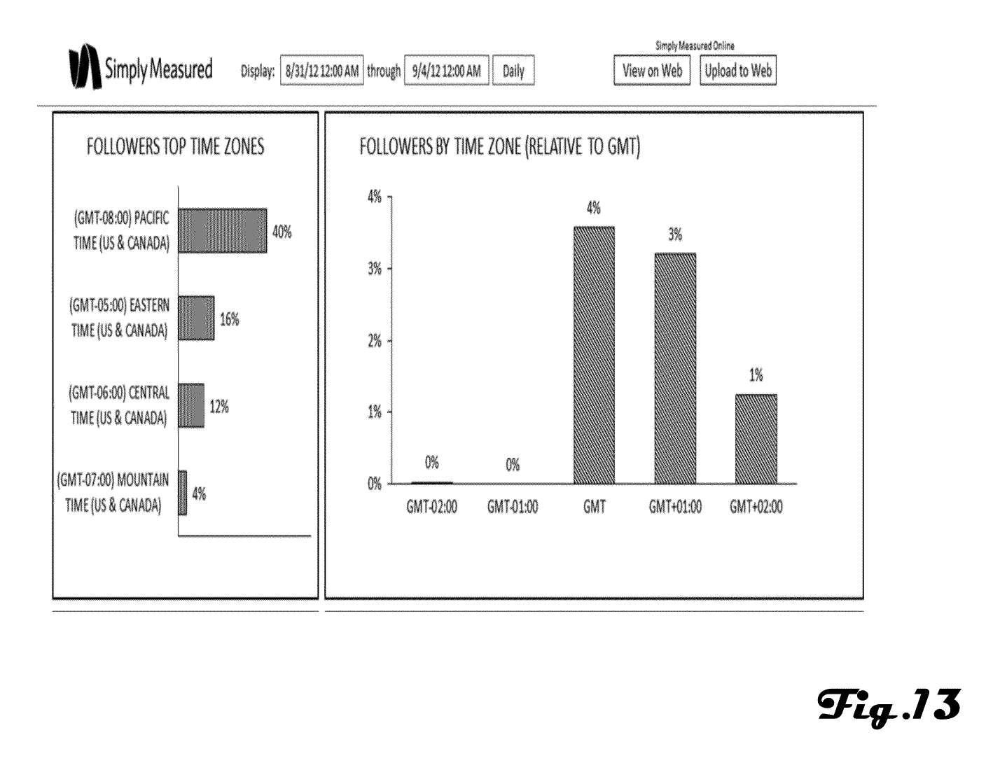

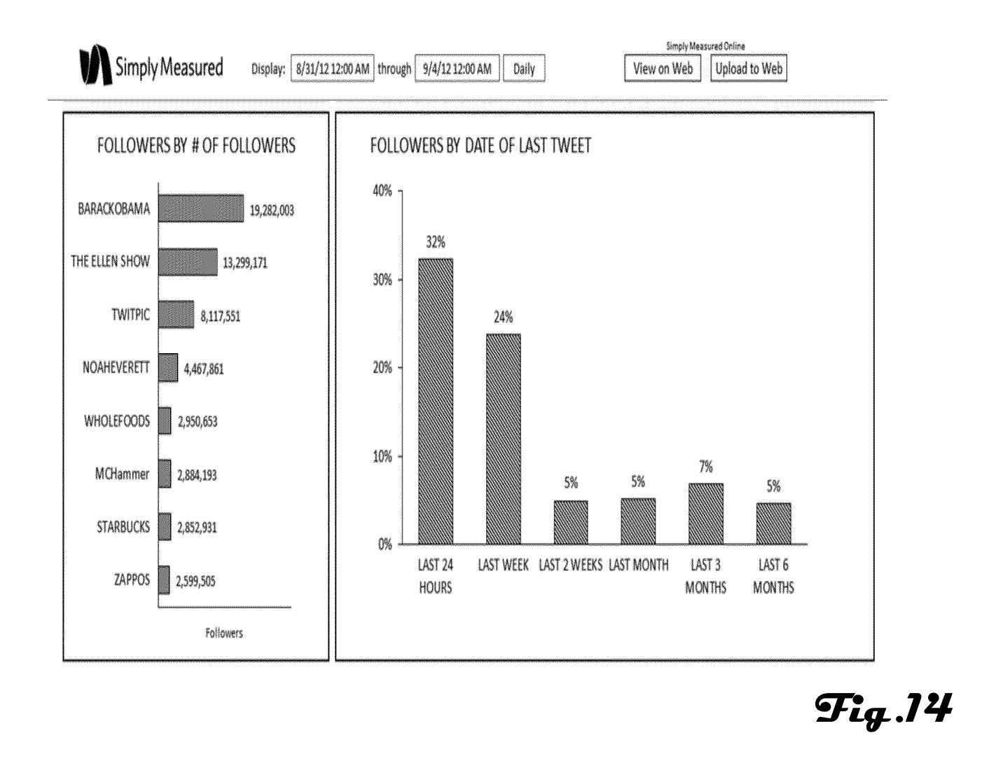

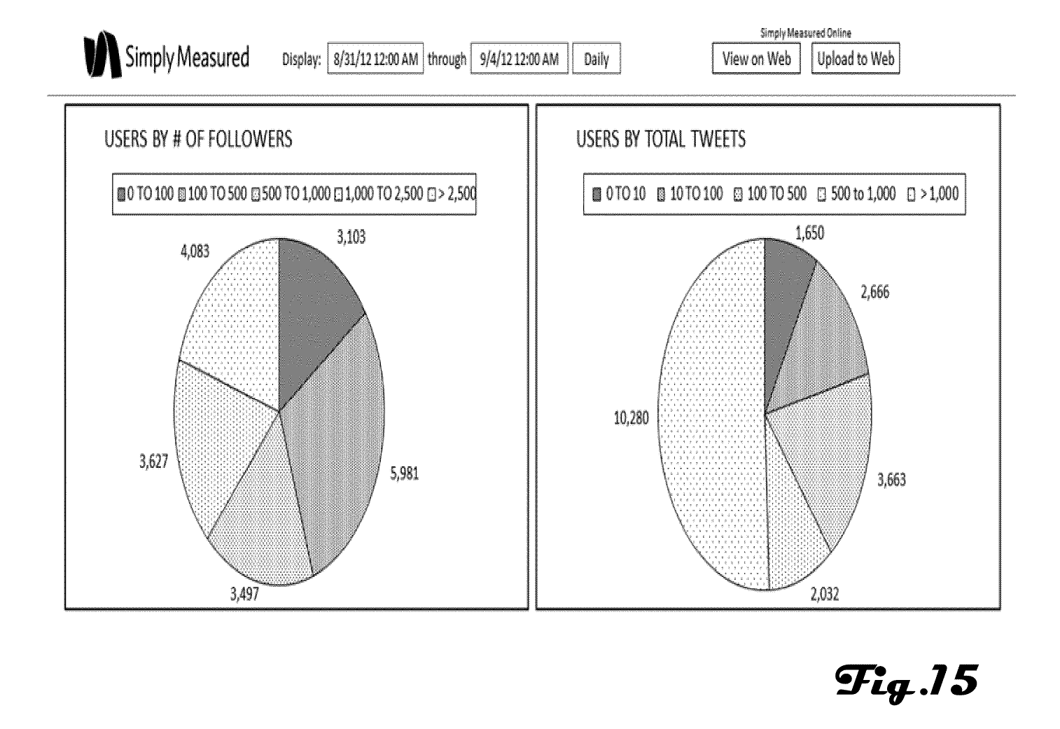

FIGS. 11-15 illustrate various additional non-spreadsheet charting reports that may be designed and generated according to methods such as those described herein.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

We claim:

1. A computer-implemented method for defining a non-spreadsheet charting report based on at least one spreadsheet-chart element, the method comprising:
collecting, by the computer on an ongoing basis, a data feed from a remote data source;
receiving, by the computer from a remote user device, a request for an editable document for designing and/or modifying at least one presentation-chart element related to said data feed;
obtaining, by the computer, a first data snapshot of current data collected from said remote data source, a data snapshot comprising a first multiplicity of records, each record having a plurality of collected-data fields;
obtaining, by the computer, a spreadsheet template corresponding to said remote data source, said spreadsheet template mapping said plurality of collected-data fields to a plurality of spreadsheet columns;
generating, by the computer, a snapshot spreadsheet comprising said plurality of spreadsheet columns and a multiplicity of spreadsheet rows respectively populated with a multiplicity of records according to said spreadsheet template;
providing, by the computer, said snapshot spreadsheet to said remote user device for modification including inserting and/or modifying the at least one spreadsheet-chart element to graphically depict a quantity and/or data relationship of said data snapshot;
receiving, by the computer from said remote user device, said snapshot spreadsheet in modified form, including the at least one spreadsheet-chart element as inserted and/or modified;
extracting, by the computer, report-presentation meta-data from the at least one spreadsheet-chart element;
generating, by the computer based at least in part on said report-presentation meta-data, a report-presentation template including said at least one presentation-chart element corresponding to the at least one spreadsheet-chart element; and
storing, by the computer, said report-presentation template in a data store for subsequent use to generate the non-spreadsheet charting report.

2. The method of claim 1, further comprising
receiving a request to present the non-spreadsheet charting report;
retrieving said report-presentation template from said data store;
obtaining a second data snapshot comprising updated data collected from said remote data source, said second data snapshot including data collected subsequently to the data of said data snapshot; and
based at least in part on said report-presentation template and said second data snapshot, generating the non-spreadsheet charting report for presentation to a remote user in a non-spreadsheet format, the non-spreadsheet charting report comprising said at least one presentation-chart element graphically depicting said quantity and/or data relationship of said second data snapshot.

3. The method of claim 2, wherein generating the non-spreadsheet charting report comprises generating a dynamic presentation web page for rendering by a remote web browser.

4. The method of claim 2, wherein generating the non-spreadsheet charting report comprises generating a static presentation document for rendering by a presentation software program executed by a remote client device.

5. The method of claim 1, wherein extracting said report-presentation meta-data comprises identifying one or more of said plurality of spreadsheet columns as being source columns providing data depicted by the at least one spreadsheet-chart element.

6. The method of claim 5, wherein the identified source columns are identified based at least in part on said spreadsheet template.

7. The method of claim 5, wherein identifying the identified source columns comprises, for each source column of the identified source columns:
identifying a named range of spreadsheet cells, said named range being associated with a range name in a modified snapshot spreadsheet; and
identifying the source column based at least in part on said range name.

8. The method of claim 5, wherein generating said report-presentation template comprises identifying one or more of said plurality of collected-data fields as being mapped fields that map to the identified source columns.

9. The method of claim 1, wherein generating said snapshot spreadsheet comprises, for each source data-field of said plurality of collected-data fields:
determining an identifier corresponding to the source data-field;
determining a column of said snapshot spreadsheet to correspond to the source data-field, said column corresponding to a range of spreadsheet cells;
creating in said snapshot spreadsheet a named range corresponding to said range of spreadsheet cells; and
naming said named range according to said identifier.

10. The method of claim 1, wherein said data feed comprises a feed provided by a remote social networking service or a remote micro-blogging service.

11. The method of claim 1, wherein said data feed comprises at least one of:
web analytics data;
email marketing data;
social advertising data;
search-engine optimization data;
search-engine marketing data;
paid media data;
customer relationship management data; and
marketing automation data.

12. A computing apparatus comprising a processor and a memory having stored therein instructions that when executed by the processor, configure the apparatus to perform a method for defining a non-spreadsheet charting report based on at least one spreadsheet-chart element, the method comprising:
collecting, on an ongoing basis, a data feed from a remote data source;
receiving, from a remote user device, a request for an editable document for designing and/or modifying at least one presentation-chart element related to said data feed;
obtaining a first data snapshot of current data collected from said remote data source, a data snapshot comprising a first multiplicity of records, each record having a plurality of collected-data fields;
obtaining a spreadsheet template corresponding to said remote data source, said spreadsheet template mapping said plurality of collected-data fields to a plurality of spreadsheet columns;
generating a snapshot spreadsheet comprising said plurality of spreadsheet columns and a multiplicity of spreadsheet rows respectively populated with a multiplicity of records according to said spreadsheet template;
providing said snapshot spreadsheet to said remote user device for modification including inserting and/or modifying the at least one spreadsheet-chart element to graphically depict a quantity and/or data relationship of said data snapshot;
receiving, from said remote user device, said snapshot spreadsheet in modified form, including the at least one spreadsheet-chart element as inserted and/or modified;
extracting report-presentation meta-data from the at least one spreadsheet-chart element;
generating, based at least in part on said report-presentation meta-data, a report-presentation template including said at least one presentation-chart element corresponding to the at least one spreadsheet-chart element; and
storing said report-presentation template in a data store for subsequent use to generate the non-spreadsheet charting report.

13. The apparatus of claim 12, further comprising:
receiving a request to present the non-spreadsheet charting report;
retrieving said report-presentation template from said data store;
obtaining a second data snapshot comprising updated data collected from said remote data source, said second data snapshot including data collected subsequently to the data of said data snapshot; and
based at least in part on said report-presentation template and said second data snapshot, generating the non-spreadsheet charting report for presentation to a remote user in a non-spreadsheet format, the non-spreadsheet charting report comprising said at least one presentation-chart element graphically depicting said quantity and/or data relationship of said second data snapshot.

14. The apparatus of claim 13, wherein generating the non-spreadsheet charting report comprises generating a dynamic presentation web page for rendering by a remote web browser.

15. The apparatus of claim 13, wherein generating the non-spreadsheet charting report comprises generating a static presentation document for rendering by a presentation software program executed by a remote client device.

16. The apparatus of claim 12, wherein extracting said report-presentation meta-data comprises identifying one or more of said plurality of spreadsheet columns as being source columns providing data depicted by the at least one spreadsheet-chart element.

17. A non-transient computer-readable storage medium having stored therein instructions that when executed by a processor, configure the processor to perform a method for defining a non-spreadsheet charting report based on at least one spreadsheet-chart element, the method comprising:
collecting, on an ongoing basis, a data feed from a remote data source;
receiving, from a remote user device, a request for an editable document for designing and/or modifying at least one presentation-chart element related to said data feed;
obtaining a first data snapshot of current data collected from said remote data source, a data snapshot comprising a first multiplicity of records, each record having a plurality of collected-data fields;
obtaining a spreadsheet template corresponding to said remote data source, said spreadsheet template mapping said plurality of collected-data fields to a plurality of spreadsheet columns;
generating a snapshot spreadsheet comprising said plurality of spreadsheet columns and a multiplicity of spreadsheet rows respectively populated with a multiplicity of records according to said spreadsheet template;
providing said snapshot spreadsheet to said remote user device for modification including inserting and/or modifying the at least one spreadsheet-chart element to graphically depict a quantity and/or data relationship of said data snapshot;
receiving, from said remote user device, said snapshot spreadsheet in modified form, including the at least one spreadsheet-chart element as inserted and/or modified;
extracting report-presentation meta-data from the at least one spreadsheet-chart element;
generating, based at least in part on said report-presentation meta-data, a report-presentation template including said at least one presentation-chart element corresponding to the at least one spreadsheet-chart element; and
storing said report-presentation template in a data store for subsequent use to generate the non-spreadsheet charting report.

18. The storage medium of claim 17, further comprising:
receiving a request to present the non-spreadsheet charting report;
retrieving said report-presentation template from said data store;
obtaining a second data snapshot comprising updated data collected from said remote data source, said second data snapshot including data collected subsequently to the data of said data snapshot; and
based at least in part on said report-presentation template and said second data snapshot, generating the non-spreadsheet charting report for presentation to a remote user in a non-spreadsheet format, the non-spreadsheet charting report comprising said at least one presentation-chart element graphically depicting said quantity and/or data relationship of said second data snapshot.

19. The storage medium of claim 18, wherein generating the non-spreadsheet charting report comprises generating a dynamic presentation web page for rendering by a remote web browser.

20. The storage medium of claim 18, wherein generating the non-spreadsheet charting report comprises generating a static presentation document for rendering by a presentation software program executed by a remote client device.

21. The storage medium of claim 17, wherein extracting said report-presentation meta-data comprises identifying one or more of said plurality of spreadsheet columns as being source columns providing data depicted by the at least one spreadsheet-chart element.
